(19) United States
(12) Patent Application Publication
(10) Pub. No.: US 2018/0288996 A1
(43) Pub. Date: Oct. 11, 2018

(54) Game Carrier and Dressing Apparatus

(71) Applicants: John Shonka, Warren, MI (US); Julia Shonka, Warren, MI (US)

(72) Inventors: John Shonka, Warren, MI (US); Julia Shonka, Warren, MI (US)

(21) Appl. No.: 15/484,773

(22) Filed: Apr. 11, 2017

(51) Int. Cl. A01M 31/00; B62B 1/00; B62B 1/12; B62B 5/06

(52) U.S. Cl. CPC A01M 31/006; B62B 1/008; B62B 2205/00; B62B 5/067; B62B 2202/42; B62B 1/12

(57) ABSTRACT

A game carrier and dressing apparatus including a carriage bed having a left side, a right side, a front side, and a back side. A towing handle assembly having a front handle and a structure interconnected between the front handle to the back side of the carrying bed. A wheel mounted assembly adjustably connected to the back side of the carrying bed by a rear support having a left support member, a vertical right support member, and a horizontal beam support member having a pneumatic lifter. An axel assembly having a left wheel and a right wheel rotatably mounted to the left support member and the right support member. A front support stand adjustably connected to ii the elongated carrying bed. The front support stand having a vertical left having a pneumatic rod extended.

Be it known that we citizens of the United States, have invented new and useful improvements in a game carrier and dressing apparatus as described in this specification.

### BACKGROUND OF THE INVENTION

Various types of game carrier and dressing apparatuses are known in the prior art. However, what has been needed is a game carrier and dressing apparatus including a carrying bed having a front side and a back side. What has been further needed is a towing handle assembly attachable to the back side of the carrying bed. What has also been needed is a wheel mounted assembly disposed on the back side of the carrying bed. An adjustable pneumatic lifter extends from the wheel mounted assembly. Lastly, there is a front support stand connected to the front side of the carrying bed with an adjustable pneumatic rod. The game carrier and dressing apparatus thus enables a user to not only transport a harvested animal from the field, but also to be used as a workstation to field dress the animal.

### FIELD OF THE INVENTION

The present invention relates to a game carrier and dressing apparatus, and more particularly, to a game carrier and dressing apparatus that can not only enable a user to transport a harvested animal from the field, but to be used as a workstation to field dress the animal.

### SUMMARY OF THE INVENTION

The general purpose of the game carrier and dressing apparatus described subsequently in greater detail, is to provide the game carrier and dressing apparatus which has many novel features that result in a game carrier and dressing apparatus which is not anticipated, rendered obvious, suggested, or even implied by prior art, either alone or in combination thereof.

To accomplish this, the game carrier and dressing apparatus includes a carriage having a adjustable elongated carrying bed. The carrying bed has a left side, a right side, a front side, a back side, and a plurality of horizontal flat slats attachable to each of the left side of the carrying bed and the right side of the carrying bed. Furthermore, the game carrier and dressing apparatus has a towing handle assembly having a front handle and a structure interconnected between the front handle to the back side of the carrying bed. The game carrier and dressing apparatus also has a wheel mounted assembly adjustably connected to opposite sides of the back side of the carrying bed. The wheel mounted assembly has a rear support with a vertical left support member, a vertical right support member, and a horizontal support beam fixably attached to the left support member and right support member. A adjustable pneumatic lifter extends from the horizontal support beam. There is an axel assembly on the wheel mounted assembly having a left wheel rotatably mounted the vertical left support member and a right wheel rotatably mounted to the vertical right support member.

The game carrier and dressing apparatus further has a front support stand adjustably connected to opposite sides of the front side of the elongated carrying bed. The front support stand has a vertical left support leg, a vertical right support leg, and a horizontal joist support fixably attached to the left support leg of the front support stand and right support leg of the front support stand. Lastly, an adjustable pneumatic rod extends from the horizontal joist support of the front support stand.

Thus has been broadly outlined the more important features of the game carrier and dressing apparatus so that the detailed description thereof that follows may be better understood and in order that the present contribution to the art may be better appreciated.

### BRIEF DESCRIPTION OF THE DRAWINGS

### Figures

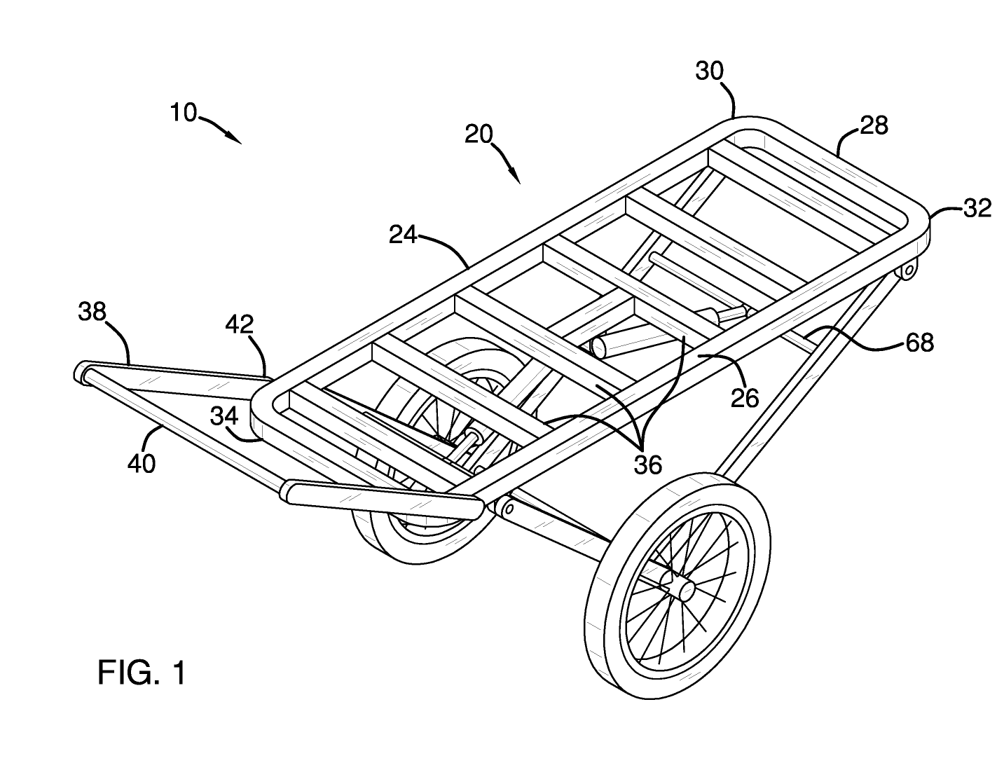

FIG. 1 is a front isometric view.

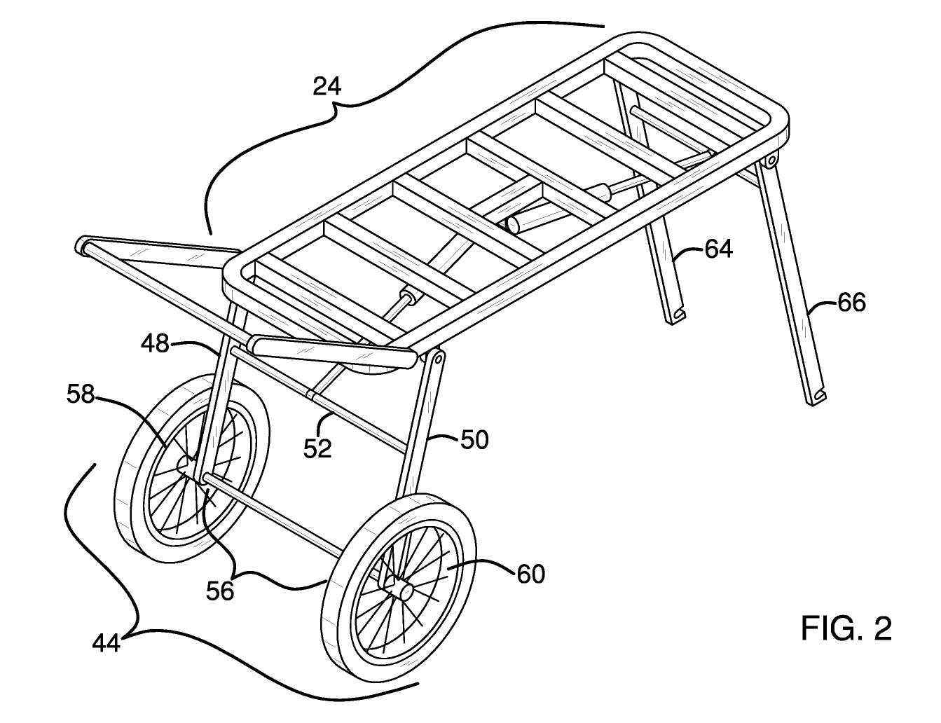

FIG. 2 is a front elevation view showing a pair of legs in an extended position.

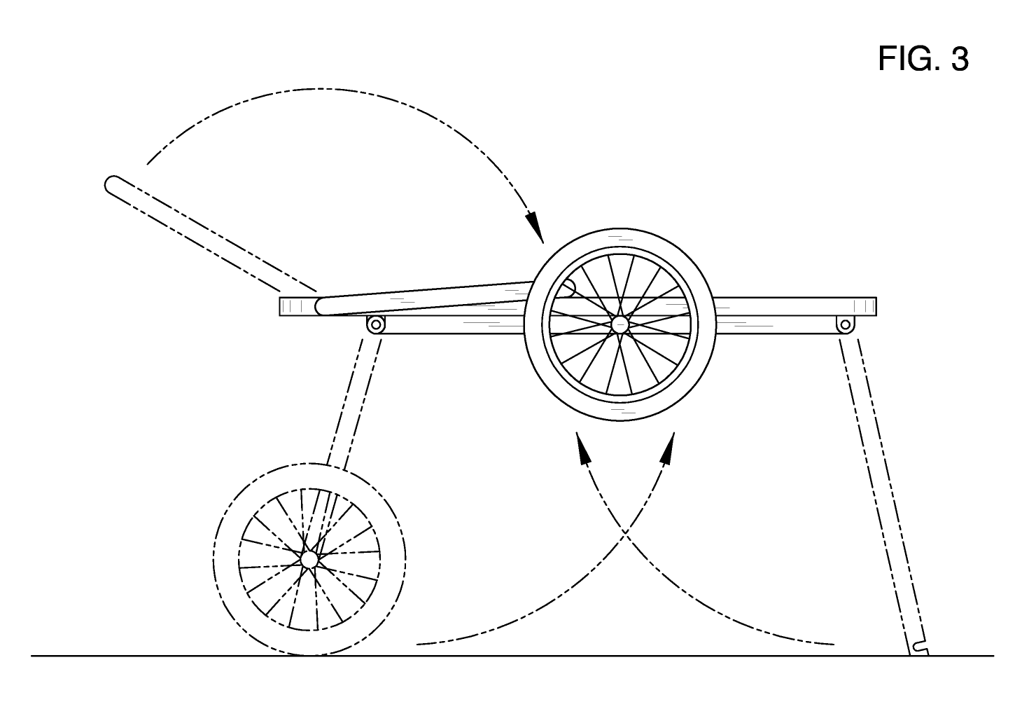

FIG. 3 is a side view showing the pair of legs in an alternate folded position.

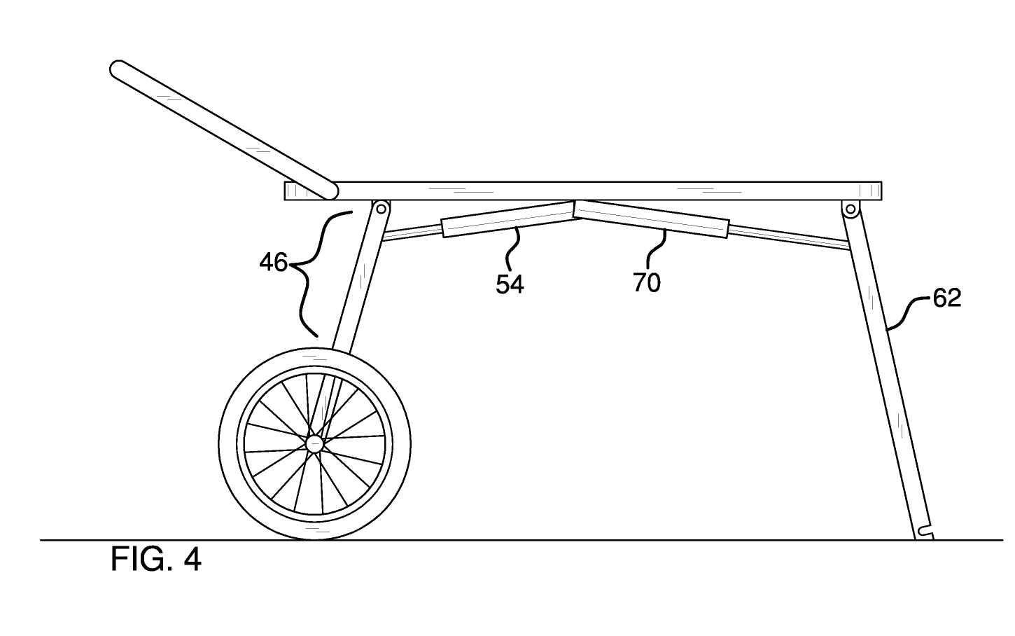

FIG. 4 is a side view showing the pair of legs in the extended position.

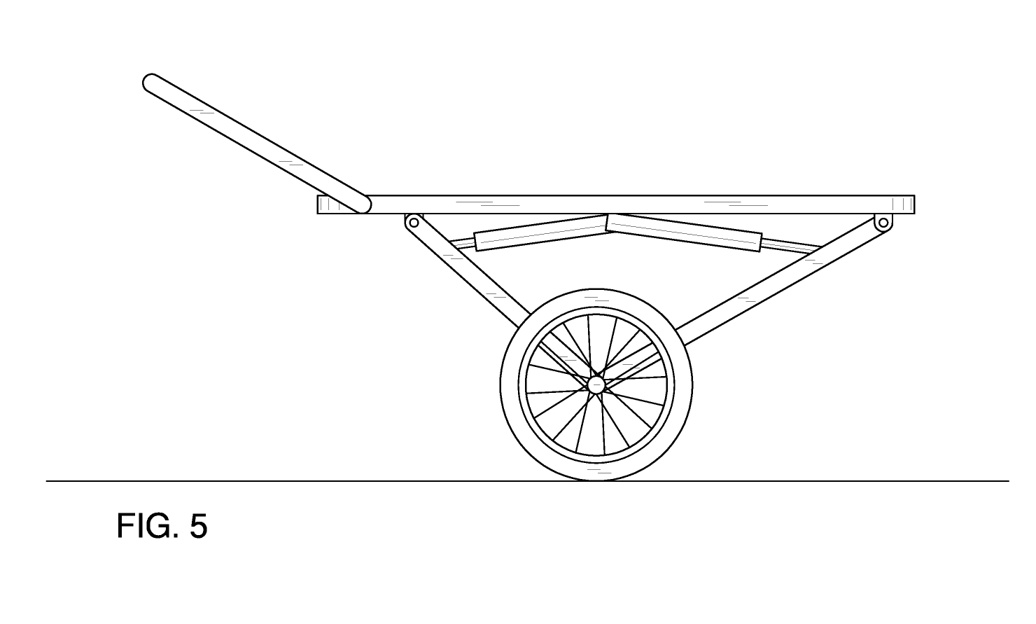

FIG. 5 is a side elevation view.

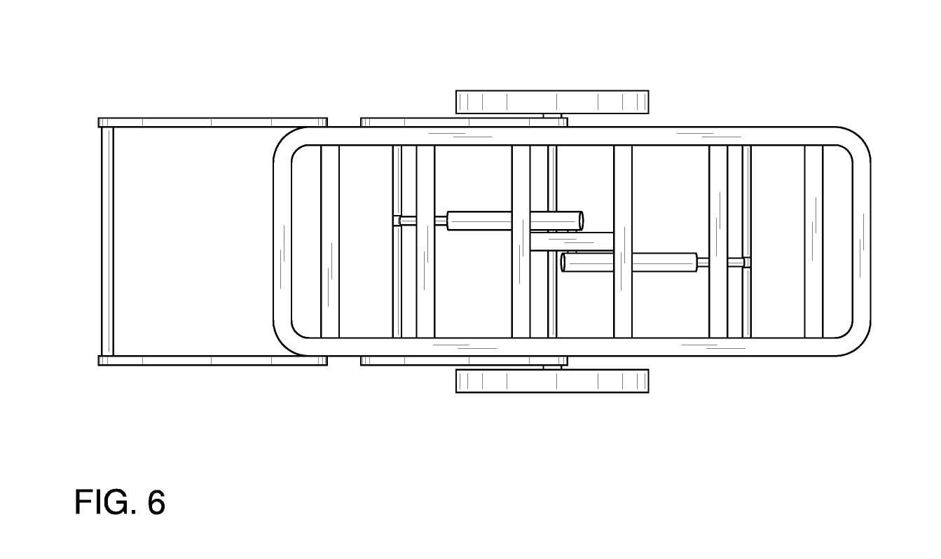

FIG. 6 is a top plain view.

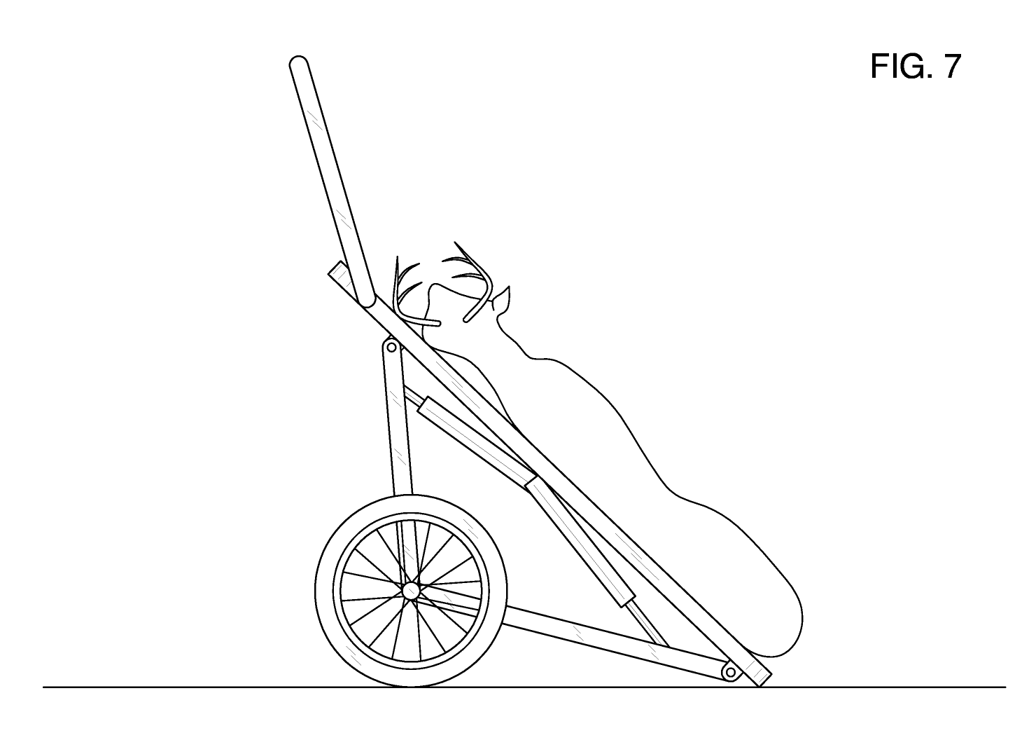

FIG. 7 is an in use view.

### DETAILED DESCRIPTION OF THE DRAWINGS

With reference now to the drawings, and in particular FIGS. 1 through 7 thereof, an example of the game carrier and dressing apparatus employing the principles and concepts of the present headlock lift and generally designated by the reference number 10 will be described.

Referring to FIGS. 1 through 7 the present game carrier and dressing apparatus 10 is illustrated. The game carrier and dressing apparatus 10 includes a carriage 20 that has an elongated carrying bed 22 with a left side 24, a right side 26, a front side 28, a left front side 30, a right front side 32, a back side 34, and a plurality of horizontal flat slats 36 attachable to the left side 24 of the carrying bed 22 and the right side 26 of the carrying bed 22. Furthermore, the game carrier and dressing apparatus has a towing handle assembly 38 with a front handle 40 and a structure 42 interconnected between the front handle 40 to the back side 34 of the carrying bed 22. The game carrier and dressing apparatus 10 also has a wheel mounted assembly 44 adjustably connected to opposite sides of the back side 34 of the carrying bed 22. The wheel mounted assembly 44 has a rear support 46 with a vertical left support member 48, a vertical right support member 50, and a horizontal beam support 52 fixably attached to the left support member 48 and right support member 50. An adjustable pneumatic lifter 54 extends from the horizontal support member 52. There is an axel assembly 56 on the wheel mounted assembly 44 with a left wheel 58 rotatably mounted to the vertical left support member 48 and a right wheel 60 rotatably mounted to the vertical right support member 50.

The game carrier and dressing apparatus 10 further has a front support stand 62 adjustably connected to the left front side 30 of the carrying bed 22 and the right front side 32 of the carrying bed 22. The front support stand 60 has a vertical left support leg 64, a vertical right support leg 66, and a horizontal joist support 68 fixably attached between the left support leg 64 and right support leg 66. Lastly, an adjustable pneumatic rod 70 extended from the horizontal joist support leg 66 of the front support stand 62.

What is claimed is:

1. A game carrier and dressing apparatus comprising:
a carriage having a adjustable elongated carrying bed, wherein the carrying bed has a left side, a right side, a front side, a right front side, a left front side, a back side, and a plurality of horizontal flat slats fixably attachable to each of the left side of the carrying bed and the right side of the carrying bed;
a towing handle assembly having a front handle and a structure interconnected between the front handle to the back side of the adjustable elongated carrying bed;
a wheel mounted assembly adjustably connected to opposite sides of the back side of elongated carrying bed by a rear support, wherein the rear support having a vertical left support member, a vertical right support member, and a horizontal beam support member fixably attached to the left support member of the wheel mounted assembly and right support member of the wheel mounted assembly;
an adjustable pneumatic lifter extended from the horizontal beam support member;
an axel assembly having a left wheel rotatably mounted to the vertical left support member and a right wheel rotatably mounted to the vertical right support member;
a front support stand adjustably connected to the left front side and right front side of the elongated carrying bed, wherein the front support stand having a vertical left support leg and a vertical right support leg, and a horizontal joist support fixably attached to the left support leg of the front support stand and right support leg of the front support stand; and
an adjustable pneumatic rod extended from the horizontal joist support of the front support stand.

2. The game carrier and dressing apparatus of claim 1 wherein the carriage is one of an aluminum or steel.
